(19) United States
(12) Patent Application Publication
(10) Pub. No.: US 2025/0051693 A1
(43) Pub. Date: Feb. 13, 2025

(54) DISSOLVABLE AND DISPERSABLE BLEACH SHEET

(71) Applicant: SHEETS LAUNDRY CLUB INC., MOORESVILLE, NC (US)

(72) Inventor: MARIO TREMBLAY, ST. PETERSBURG, FL (US)

(21) Appl. No.: 18/911,198

(22) Filed: Oct. 9, 2024

Related U.S. Application Data
(60) Provisional application No. 63/657,586, filed on Jun. 7, 2024.
(60) Provisional application No. 63/531,580, filed on Aug. 9, 2023.
(60) Provisional application No. 63/531,582, filed on Aug. 9, 2023.

(51) Int. Cl. C11D 3/395; C11D 3/00; C11D 3/20; C11D 3/22; C11D 3/37; C11D 3/39; C11D 11/00; C11D 17/04

(52) U.S. Cl. CPC C11D 3/3953; C11D 3/001; C11D 3/2065; C11D 3/222; C11D 3/3753; C11D 3/3942; C11D 3/3951; C11D 11/00; C11D 17/044

(57) ABSTRACT

The described invention is a bleach sheet made of a dissolvable film forming polymer such as PVA, or a dispersible film forming polymer such as cellulose-based film, and combined with a bleaching agent and a manufacturing method thereof. Once the sheet is added to water, it then dissolves or disperses completely in water. The ingredients that are mixed to form the dissolvable or dispersible sheet produce a liquid that can be converted into a solid and then a flexible sheet once it is dry and may be used as a bleach.

### FIELD OF THE INVENTION

This invention relates to a bleach product in the form of a dissolvable or dispersible bleach sheet containing polyvinyl alcohol and various cleaning compositions and methods for a wide range of applications.

### BACKGROUND OF THE INVENTION

This invention relates to a bleach product in the form of a dissolvable or dispersible bleach sheet. This invention relates to a bleach sheet in a pre-measured form which can be used to meter the dose. By leveraging the bleaching action of a bleaching agent in a bleach sheet form, while preventing the bleaching composition from reacting with the bleach sheet, several applications, such as bleaching or disinfection or a combination thereof may be achieved. An example is to use said bleach sheet to eliminate the odor that develops over time in wash machines, and especially that of front-loading wash machines. Accordingly there remains a need for a bleach cleaning sheet that doesn't require any of these many types of bleach ingredients added separately or added together.

### SUMMARY OF THE INVENTION

The invention relates to a dissolvable or dispersible bleach sheet and a manufacturing method thereof that can effectively deliver the full bleaching power of bleach. In the present invention, a bleach sheet includes a water dissolvable film or water dispersible film, one or more bleaching agents, one or more bleaching activator, and one or more pH increasing agents used to deliver a dissolvable or dispersible bleach sheet. The present invention is a dissolvable or dispersible bleach sheet manufactured using a water dissolvable film or a water dispersible film, prepared by removing a solvent from a solution containing a film-forming water dissolvable polymer or a film forming water-dispersible polymer. It is characterized by providing a dissolvable or dispersible bleach sheet in which an active ingredient for bleaching doesn't negatively interact with the bleach sheet composition and wherein said bleaching effect is delivered by adding the bleach sheet to water or water-based compositions. The bleaching agent may be in a form that is fully dissolved, partially dissolved, or not dissolved in the final manufacturing form of the bleach sheet. If the bleaching agent is not dissolved in the composition, it reduces the potential to negatively interact with the bleach sheet during and after manufacturing. The active ingredient for bleaching may be in a granular form and distributed in the bleach sheet. Various coatings will be disclosed to prevent the dissolution of the bleach granules during the manufacturing of the bleach sheet. Said bleach sheet can be prepared as a solution formed by mixing a water dissolvable polymer for film formation or a water dispersible polymer for film formation but is not limited to the production method. Any form in which the bleaching component is included in the film may be included in the above.

### BRIEF DESCRIPTION OF THE FIGURES

FIG. 1 is an illustration of a non-limiting embodiment of a homogenizer assembly, component feeds, and drum dryer assembly according to the invention.

FIG. 2 is an illustration of a non-limiting embodiment in a perspective view showing the dimensions of a water dissolvable PVA sheet according to the invention.

FIG. 3 is a photo representation of a top view of a non-limiting embodiment showing ruler dimensions of a water dissolvable PVA sheet according to the invention.

FIG. 4 is a photo representation of a side view of a non-limiting embodiment showing ruler dimensions of a water dissolvable PVA sheet according to the invention.

FIG. 5 is a flow chart illustration of a non-limiting embodiment of a method of manufacturing a water dissolvable PVA sheet using a homogenizer assembly, a supply for component feeds, and a drum dryer assembly according to the invention.

FIG. 6 is a perspective illustration of a non-limiting embodiment of a drum dryer assembly showing a drum drive and a sheet winding assembly according to the invention.

FIG. 7 is a perspective illustration of a non-limiting embodiment of a drum dryer assembly showing a drum drive according to the invention.

FIG. 8 is a perspective illustration of a non-limiting embodiment of a drum dryer assembly showing a drum drive and steam inlet according to the invention.

FIG. 9 is an side view illustration of a non-limiting embodiment of a drum dryer assembly showing a drum drive, a steam inlet, and applicator roller tray according to the invention.

FIG. 10 is an end view illustration of a non-limiting embodiment of a drum dryer assembly showing a drum drive, motor, and sheet winding assembly according to the invention.

FIG. 11 is a top view illustration of a non-limiting embodiment of a drum dryer assembly showing a drum drive, motor, and sheet winding assembly according to the invention.

FIG. 12 is a cut-away view illustration of a non-limiting embodiment of a drum dryer assembly showing a drum drive, motor, dryer drum, roller tray, roller, and steam delivery conduit according to the invention.

FIG. 13 is an perspective illustration of a non-limiting embodiment of an applicator roller tray, and roller assembly according to the invention.

FIG. 14 is an perspective illustration of a non-limiting embodiment of an applicator roller tray, and roller assembly according to the invention.

FIG. 15 is an perspective illustration of a non-limiting embodiment of a tray raising/lowering assembly according to the invention.

FIG. 16 is a side view illustration of a non-limiting embodiment of a tray raising/lowering assembly according to the invention.

FIG. 17 is an perspective illustration of a non-limiting embodiment of an applicator tray, roller, and tray raising/lowering assembly according to the invention.

FIG. 18 is an perspective illustration of a non-limiting embodiment of a (sheet) feed leveling roller assembly according to the invention.

FIG. 19 is a detail illustration of a non-limiting embodiment of a leveling adjustment mechanism for the (sheet) feed leveling roller assembly according to the invention.

### DETAILED DESCRIPTION OF THE INVENTION

It has been demonstrated that a bleaching composition can be prepared in sheet form that is dissolvable or dispersible in water. These bleach sheet compositions include the combination of a water dissolvable film or water dispersible film forming sheet combined with a bleaching agent. An example of beaching may be percarbonate or perborate or a combination thereof. Said bleaching agent may be in the form of a granule. Said bleaching agent granule may further be encapsulated to protect the bleaching agent during manufacturing and storage. Additionally, a pH modifier may be added to increase the generation of oxygen bleach when using said bleaching agents. Furthermore, a bleach activator such as NOBS or TAED or a combination thereof may be added to the dissolvable or dispersible bleach sheet to form peracid which increases the bleaching performance of said bleach sheet.

Currently, dissolvable and dispersible polymer films are widely used in laundry applications, but also in personal care products such as pharmaceuticals and cosmetics, and household products such as household goods. Dissolvable laundry detergent sheets which comprise of mixing active ingredients for laundry such as a detergent into a water-soluble polymer film-forming composition are available today. Dissolvable sheets are used in laundry and other applications. Dissolvable laundry sheets, which contain a laundry detergent formula, are made from synthetic film forming polymers such as Polyvinyl Alcohol (PVA). Natural polymers used in the formulation of film include starches, gums, and cellulose. These dissolvable sheets are pre-measured laundry detergent sheets that dissolves in water and acts as a cleaning composition. A thickening agent such as starch may be added to said composition to produce a sheet that remains solid and flexible upon drying. However, if the laundry detergent comprises bleach, the bleach may be activated in a film-forming water-soluble polymer during or after manufacturing of said bleach sheet, the composition becomes unstable and the active ingredients for washing will be damaged or even destroyed. As a result, the problem associated with the stabilization of bleach in the bleach sheet composition and the manufacturing of said bleach sheet needs to be resolved for the ability to deliver the full effect of bleach in a dissolvable or dispersible bleach sheet.

Bleach is a strong and effective disinfectant. Bleaches are commonly found in two forms: chlorine bleaches, which are some forms of hypochlorite, and oxygen bleaches based on primary ingredients, such as peroxides, percarbonate, perborates, etc. Chlorine bleach comes in liquid and powder form. Chlorine bleach contains sodium hypochlorite diluted in water. This type of bleach is very powerful. Chlorine bleach has a whitening and brightening effect on white fabric.

It disinfects laundry but it is not safe on colored fabric and certain synthetic fabric. Chlorine bleach can lead to splotchy fading and even to holes and damage to the fabric. Chlorine bleaches have the advantages of lower cost and have a high level of bleaching power. However, chlorine bleach can damage some colors and fabrics and the bleach must be added to the wash water in dilute amounts. These compositions have not been usable in the space of water-soluble films as they are too oxidative and will not only damage the clothing but also the polymer film matrix. There have been attempts to utilize these chlorine bleaches in soluble sheets but due to its strong oxidative power, there are no such chlorine bleach sheets on the market today. There are also other items that have bleaching power and can act as bleaching agents. One of the common uses of bleach is laundry as it removes stains from clothing, but it also removes color from clothes.

Oxygen beach is another form of bleach that is safe for use on most fabrics and is sometime referred to as color safe bleach or all-fabric bleach. Unlike chlorine bleach, this type of bleach does not typically remove color or patterns from the fabrics. There are 3 types of oxygen bleaches on the market. These are Hydrogen Peroxide that is liquid and Sodium Percarbonate and Sodium Perborate, that are powders which may be made from a natural plant derivative product. Once the percarbonate or perborate are exposed to water it releases oxygen and produces hydrogen peroxide, resulting in a much more effective and safer bleach than chlorine bleach. Oxygen bleach can also be used to disinfect, deodorize smells, and even reducing or killing microorganisms. Powdered oxygen bleach can be mixed with soda ash, which is sodium carbonate, to increase the pH of the solution and thus it increases the amount of hydrogen peroxide generated upon combining these ingredients. The addition of a bleach activator such as NOBS (Sodium nonaoyloxybenzenesulfonate) or TAED (Tetraacetylethylenediamine) or a combination thereof, which significantly increase the bleaching power of the composition. The preferable ratio of bleach activator to sodium percarbonate or sodium persulfate is from 1:4 to 1:1 and preferably 1:3 to 1:2 weight to weight ratio. Bleach activators react with hydrogen peroxide to form peroxy acids or peracids. Peroxy acids or peracids are more active than bleaches at lower temperature (<60 C) but are typically too active to be stored in their active form in situ. Several common items can also be used as bleaching agents. While they may not be as tough as chlorine bleach, they still are capable of fading or discoloring fabrics. There are natural solutions, such as lemon juice that can sit on clothes in the sun and result in a bleaching effect. Vinegar can act as a mild bleach for some clothing. Hydrogen peroxide can also be used on colorfast fabric as if it were oxygen bleach.

The problem to be solved in the present invention is to provide a dissolvable or dispersible bleach sheet and a manufacturing method thereof that can effectively deliver the full bleaching power of bleach. Said bleaching performance may be improved by increasing the pH of the composition. The pH of the composition in water needs to be alkaline with a pH greater than 9 and preferably greater than 10 and even more preferably greater than 11 for the bleach composition to produce oxygen bleach. Furthermore, even higher bleaching can be achieved by combining a bleaching activator with the active ingredients of said composition. The addition of a bleach activator such as NOBS or TAED may significantly increase the bleach effect and bleaching at lower temperatures. In order to solve the problems when combining bleach with a dissolvable or dispersible bleach sheet, the bleach granules may be coated and not dissolved until the bleach sheet is fully dissolved or fully dispersed in the water used during the application. Additionally, the bleach component or bleach granules may be introduced between two sheets and pressed together into a single bleach sheet.

In the present invention, any one or more components selected from the group consisting of a water dissolvable film or water dispersible film, one or more bleaching agent, one or more bleaching activator, and one or more pH increasing agent may be used to deliver a dissolvable or dispersible bleach sheet.

The present invention is a dissolvable or dispersible bleach sheet manufactured using a water dissolvable film or a water dispersible film, prepared by removing a solvent from a solution containing a film-forming water dissolvable polymer or a film forming water-dispersible polymer. It is characterized by providing a dissolvable or dispersible bleach sheet in which an active ingredient for bleaching doesn't negatively interact with the bleach sheet composition and wherein said bleaching effect is delivered by adding the bleach sheet to water or water-based compositions. The bleaching agent may be in a form that is fully dissolved, partially dissolved, or not dissolved in the final manufacturing form of the bleach sheet. If the bleaching agent is not dissolved in the composition, it reduces the potential to negatively interact with the bleach sheet during and after manufacturing. The active ingredient for bleaching may be in a granular form and distributed in the bleach sheet. Various coatings will be disclosed to prevent the dissolution of the bleach granules during the manufacturing of the bleach sheet. Said bleach sheet can be prepared as a solution formed by mixing a water dissolvable polymer for film formation or a water dispersible polymer for film formation but is not limited to the production method. Any form in which the bleaching component is included in the film may be included in the above.

In a preferred embodiment, the invention provides a bleach composition in the form of a drum-dried water soluble sheet, comprising: a water dissolvable polymer film having a bleaching agent, a bleach activator, a pH modifier, and water 1-5% by weight, wherein the polymer is 10-20% by weight selected from the group consisting of polyvinyl alcohol, starch, and hydroxypropylcellulose, wherein the bleaching agent is 1-60% by weight, wherein the bleach activator is 1-40% by weight, wherein the pH modifier is 1-70% by weight, wherein all percentages total 100.

Any of the non-limiting embodiments may include wherein the polymer is polyvinyl alcohol.

Any of the non-limiting embodiments may include wherein the bleaching agent is selected from the group consisting of sodium hypochlorite, sodium percarbonate, and sodium perborate.

Any of the non-limiting embodiments may include wherein the bleach activator is selected from the group consisting of nonanoyloxybenzenesulfonate (NOBS), tetraacetylethylenediamine (TAED), lauryloxybenzenesulfonate (SDBS), benzoylcaprolactam (BzCL), 4-nitro Benzoylcaprolactam, 3-chlorobenzoylcaprolactam, benzoyloxybenzenesulfonate (BOBS), nonanoyloxybenzenesulfonate (NOBS), phenyl benzoate (PhBz), decanoyloxybenzenesulfonate (C 10-OBS), Benzoylvalerolactam (BZVL), octanoyloxybenzenesulfonate (C 8-OBS), a perhydrolyzable ester, and a combination thereof.

Any of the non-limiting embodiments may include wherein the pH modifying is selected from the group consisting of sodium carbonate, sodium bicarbonate, sodium hydroxide, sodium silicate and a combination thereof.

Any of the non-limiting embodiments may include wherein the bleaching agent is an encapsulated dry particulate bleaching agent.

Any of the non-limiting embodiments may include wherein the bleaching agent is an encapsulated dry particulate bleaching agent, and the bleaching agent is selected from the group consisting of sodium hypochlorite, sodium percarbonate, and sodium perborate, sodium dichloroisocyanurate dihydrate, sodium dichloroisocyanurate, potassium dichloroisocyanurate dihydrate, potassium dichloroisocyanurate, sodium perborate monohydrate, sodium perborate tetrahydrate and a combination thereof.

Any of the non-limiting embodiments may include wherein the bleaching agent is an encapsulated dry particulate bleaching agent, and the bleaching agent is selected from the group consisting of sodium hypochlorite, sodium percarbonate, and sodium perborate, sodium dichloroisocyanurate dihydrate, sodium dichloroisocyanurate, potassium dichloroisocyanurate dihydrate, potassium dichloroisocyanurate, sodium perborate monohydrate, sodium perborate tetrahydrate and a combination thereof, and wherein the encapsulant is selected from the group consisting of sulfate, carbonate, carbohydrate, starch, maltodextrin dextrin, sucrose, cellulose, agar, carrageenan, wax, paraffin, diglyceride, gluten, casein, albumin, peptide, sodium alginate, gum arabic, chitosan, carboxymethylcellulose, pectin, shellac, and a combination thereof.

Any of the non-limiting embodiments may include a surfactant selected from the group consisting of sodium lauryl sulfate, sodium dioctyl sulfosuccinate, linear alkyl benzene sulfonate, alpha olefin sulfonate, xylene sulfonate and a combination thereof.

Any of the non-limiting embodiments may include glycerin 1 to 10% by weight.

Any of the non-limiting embodiments may include a builder agent selected from the group consisting of citrate, citric acid, trisodium phosphate, zeolite, carbonate, phosphonate, and lime, in the amount of 1 to 10% by weight.

Any of the non-limiting embodiments may include a chelating agent selected from the group consisting of EDTA, MGDA, DTPA, GLDA, and HEDP, and a combination thereof 0.1 to 1% by weight.

Any of the non-limiting embodiments may include a fabric softener.

Any of the non-limiting embodiments may include wherein starch is 10-60% by weight, said starch selected from the group consisting of corn, wheat, potato, rice, or tapioca starch and a combination thereof.

Any of the non-limiting embodiments may include wherein the sheet comprises a perforated weakened tear-line.

Any of the non-limiting embodiments may include wherein the sheet comprises one or more layers, and where the layers are the same or a different composition.

Any of the non-limiting embodiments may include wherein said polyvinyl alcohol film includes a water dissolvable co-polymer of ethylene oxide, or a water dissolvable co-polymer of propylene oxide or a combination thereof.

Any of the non-limiting embodiments may include a surfactant such as an anionic surfactant, a cationic surfactant, a nonionic surfactant or a amphoteric surfactant or a combination thereof, and a binding agent, wherein the polyvinyl alcohol, surfactant, binding agent, water, or a combination thereof, are mixed and dried to form the water dissolvable bleach sheet.

In another preferred embodiment, the invention provides a method for producing a water dissolvable bleach sheet, the steps comprising: (i) dissolving polyvinyl alcohol in water to form an aqueous PVA solution; (ii) mixing a bleaching agent, a bleach activator, a pH modifier to the aqueous PVA solution, and optionally one or more of a surfactant, a builder, a binding agent, and a chelating agent to form a paste; (iii) delivering the paste to a drum dryer to form a water dissolvable bleach sheet.

Any of the non-limiting embodiments may include trimming the water dissolvable bleach sheet to a form 1.5-2.0 mm thick, 50-127 mm wide, and 76-203 mm long.

Any of the non-limiting embodiments may include wherein the polyvinyl alcohol, water, bleaching agent, bleach activator, and pH modifier are mixed in a single homogenizer tank, wherein the homogenizer tank is heated using steam, wherein the drum dryer comprises a heated drying drum having a drive system and a mirror finish, said drying drum mounted over a bottom applicator roller assembly having a bottom feed tray with a bottom feed applicator roller disposed therein, the bottom fed tray having a inlet for receiving the paste, the bottom feed applicator roller in operative contact with paste in the bottom feed tray, wherein rotational engagement between the drying drum and the bottom feed applicator roller forms a water dissolvable bleach sheet.

Any of the non-limiting embodiments may include surface spraying the water dissolvable bleach sheet with a surface agent selected from the group consisting of a bleaching agent, a bleach particle, a pH modifying agent, a bleach activator, a surfactant, a builder, a binding agent, a chelating agent, a fragrance, and a combination of one or more thereof.

In another preferred embodiment, the invention provides a water dissolvable bleach sheet, comprising: a plurality of layers of a polymeric matrix of an aqueous polymer film, the polymer 10-20% mass ratio selected from the group consisting of polyvinyl alcohol, starch, and hydroxypropylcellulose, blended with a bleaching agent, a bleach activator, and a pH modifier, wherein the aqueous polymer film, bleaching agent, bleach activator, and pH modifier are mixed together, and dried to form a water dissolvable bleach sheet.

Any of the non-limiting embodiments herein may include a surfactant 1-5%, a builder 0.1-5%, a binding agent 0.1-5%, an optional chelating agent 0.1-5%, and water 50-97.6%, by weight.

Any of the non-limiting embodiments herein may include wherein the aqueous polymer film layer is 50-100 um and wherein the sheet is a laminate having 500-5000 layers, wherein the water dissolvable bleach sheet starts to dissolve in contact with an excess of water in less than 60 seconds.

Any of the non-limiting embodiments herein may include wherein the laminate comprises biaxial layers, wherein the laminate layers are oriented as a weave, mesh, twill, satin or basket pattern, wherein the laminate is reinforced with a plurality of fibers selected from water dissolvable polymer fibers, wool fibers, cotton fibers, or hemp fibers, or wherein the laminate is reinforced with a plurality of fibers selected from water dissolvable polymer fibers, wool fibers, cotton fibers, hemp fibers, and the fibers are oriented as a weave, mesh, twill, satin or basket.

Any of the non-limiting embodiments herein may include wherein the sheet is a continuous sheet having a perforated weakened tear-line to provide separate individual sheets, or wherein the sheet is mounted on a cleaning mitt, cleaning glove, or cleaning sponge.

Any of the non-limiting embodiments herein may include wherein one or more of the layers is a hydrogel stiffener layer of polyvinyl alcohol, polysaccharide, or gelatin.

Any of the non-limiting embodiments herein may include wherein said polyvinyl alcohol film includes a water dissolvable co-polymer of ethylene oxide, or a water dissolvable co-polymer of propylene oxide or a combination thereof.

Any of the non-limiting embodiments herein may include: a surfactant such as an anionic surfactant, a cationic surfactant, a nonionic surfactant or a amphoteric surfactant or a combination thereof, and a binding agent, wherein the polyvinyl alcohol, surfactant, binding agent, water, or a combination thereof, are mixed and dried to form the water dissolvable bleach sheet.

Any of the non-limiting embodiments herein may include: wherein the surfactant constitutes between 5 to 50% by weight; wherein the sheet is 3-10% water by weight compared to the total weight of the water dissolvable bleach sheet; wherein the composition comprises at least of 0.5% to 12% copolymer by weight compared to the total weight of the water dissolvable bleach sheet; wherein the anionic surfactant composition consists of at least 5% to 40% anionic surfactant by weight compared to the total weight of the water dissolvable bleach sheet; wherein the cationic surfactant composition consists of at least 5% to 40% cationic surfactant by weight compared to the total weight of the water dissolvable bleach sheet; wherein the non-ionic surfactant composition consists of at least 5% to 40% non-ionic surfactant by weight compared to the total weight of the water dissolvable bleach sheet; wherein the amphoteric surfactant composition consists of at least 5% to 40% amphoteric surfactant by weight compared to the total weight of the water dissolvable bleach sheet; or wherein said surfactant is selected from the group consisting of sulfate, sulfonate and a mixture thereof; or wherein the anionic surfactant is selected from the group of sodium dodecylbenzene sulfonate, sodium laureth sulfate or a combination thereof.

Any of the non-limiting embodiments herein may include: a chelating agent selected from the group of EDTA, MGDA, DTPA, zeolite, phosphonate, citric acid, citrate, and a mixture thereof; a fragrance in the amount of 0 to 2% by weight; a bleaching agent is selected from the group consisting of calcium hypochlorite, sodium hypochlorite, sodium percarbonate, sodium perborate, sodium persulfate, tetrasodium pyrophosphate, urea peroxide and a combination thereof; or a fabric softener agent is selected from the group of quaternary ammonium cations/salts, cetrimonium bromide, quaternary ammonium chloride, polydimethylsiloxane, silicone, or a mixture thereof.

Any of the non-limiting embodiments herein may include: wherein the polymer matrix includes a copolymer of ethylene oxide, propylene oxide or a combination thereof; or wherein the polymer matrix comprises a copolymer in the range of 0.5% to 10% of the co-polymer by weight.

Any of the non-limiting embodiments herein may include: wherein the polymer matrix is a hydrogel comprising at least 50% water by weight.

In another preferred embodiment, the invention provides a method for producing a water dissolvable bleach sheet, the steps comprising: (i) dissolving 5000 parts of dissolvable polymer in 20000 parts of water; (ii) mixing at 70° C. 2000 parts binder, 10 parts emulsifier, 40 parts of softening agent and 5 parts of silicone oil to the polyvinyl alcohol solution; (iii) applying the mixture to a substrate form at a depth of 50-100 um and drying at a temperature of 120° C. to form a polymer film; (iv) surface treating the polymer film with a bleaching mixture to form a bleaching film, the bleaching mixture comprising a bleaching agent, a bleaching activator, and a pH modifier (v) layering the bleaching film to form a bleaching sheet having a depth from 750-7500 um (micrometers), and optionally trimming and rolling to obtain a finished bleaching sheet.

Any of the non-limiting methods herein may include the step of surface treating the polymer film with surfactant 1-5%, a builder 0.1-5%, a binding agent 0.1-5%, or a chelating agent 0.1-5%.

Any of the non-limiting methods herein may include the step of including one or more layers of a hydrogel made from polyvinyl alcohol, polysaccharide, or gelatin, the hydrogel made by a process selected from reacting with a cross-linking agent (glutaraldehyde), applying a freeze-thaw cycle, or annealing.

Any of the non-limiting methods herein may include the step of orienting the laminate layers as a weave, mesh, twill, satin or basket.

Any of the non-limiting methods herein may include the step of applying to the laminate a plurality of reinforcement fibers selected from water dissolvable polymer fibers, wool fibers, cotton fibers, hemp fibers.

Any of the non-limiting methods herein may include the step of applying to the laminate a plurality of reinforcement fibers selected from water dissolvable polymer fibers, wool fibers, cotton fibers, hemp fibers, and orienting the fibers as a weave, mesh, twill, satin or basket pattern.

Any of the non-limiting methods herein may include the step of applying to a continuous sheet a perforated weakened tear-line to provide separate individual sheets.

Any of the non-limiting embodiments herein may include: wherein the polymer comprises polyvinyl alcohol.

Any of the non-limiting embodiments herein may include: a dispersing agent selected from the group consisting of inorganic dispersant or organic dispersant or a combination thereof.

Any of the non-limiting embodiments herein may include: bleaching agent is encapsulated such that the bleaching agent is not incompatible with the dissolvable bleach sheet composition and has no adverse effect on said dissolvable bleach sheet composition.

Any of the non-limiting embodiments herein may include: wherein the bleaching agent constitutes between 1% and 60% weight to weight and preferably 2% to 50% and even more preferably 5 to 40% weight to weight ratio of the bleach sheet.

Any of the non-limiting embodiments herein may include: wherein the bleaching agent comprises hypochlorite and preferably sodium hypochlorite.

Any of the non-limiting embodiments herein may include: wherein the bleaching agent comprises percarbonate and preferably sodium percarbonate.

Any of the non-limiting embodiments herein may include: wherein the bleaching agent comprises perborate and preferably sodium perborate.

Any of the non-limiting embodiments herein may include: a dry particulate bleaching compound selected from the group consisting of sodium dichloroisocyanurate dihydrate, sodium dichloroisocyanurate, potassium dichloroisocyanurate dihydrate, potassium dichloroisocyanurate, sodium perborate monohydrate, sodium perborate tetrahydrate and sodium percarbonate or a combination thereof.

Any of the non-limiting embodiments herein may include: wherein the bleaching agent comprises an encapsulant that coats the dry particulate bleaching agent.

Any of the non-limiting embodiments herein may include: wherein the bleaching agent is encapsulated with the pH modifier agent in such a way that the pH modifier results in even greater bleaching effect than if the bleaching agent and the pH modifiers were added separately rather than encapsulated with said pH modifier.

Any of the non-limiting embodiments herein may include: wherein the encapsulant used to coat the bleaching agent comprises of a coating such as sulfate, carbonate, carbohydrate, starch, maltodextrin dextrin, sucrose, cellulose, agar, carrageenan, wax, paraffin, diglyceride, gluten, casein, albumin, peptide, sodium alginate, gum arabic, chitosan, carboxymethylcellulose, pectin and shellac or a combination thereof.

Any of the non-limiting embodiments herein may include: wherein the bleach activator is selected from NOBS, TAED, LOBS, BODA or a combination thereof.

Any of the non-limiting embodiments herein may include: a bleach activator which is added between 1 to 40% and preferably 2 to 30% and more preferably between 3 to 20% weight to weight of the sheet.

Any of the non-limiting embodiments herein may include: wherein the film forming composition constitutes between 1% to 30%, and preferably 5% to 25% and more preferably between 10% and 20% weight to weight of the sheet.

Any of the non-limiting embodiments herein may include: a starch added between 10% and 60% weight to weight ratio of the dissolvable bleach sheet and comprises one or more of corn, wheat, potato, rice, or tapioca starch or a combination thereof.

Any of the non-limiting embodiments herein may include: wherein water constitutes between 0 and 10% and preferably 2 to 8% and more preferably 3 to 6% weight to weight of the sheet.

Any of the non-limiting embodiments herein may include: a humectant such as but not limited to glycerin which is added between 1 to 10% and preferably 2 to 8% and more preferably 3 to 6% weight to weight ratio of the dissolvable bleach sheet.

Any of the non-limiting embodiments herein may include: pH modifier is selected from sodium carbonate, sodium bicarbonate, sodium hydroxide, or soda ash or a combination thereof.

Any of the non-limiting embodiments herein may include: pH modifier constitutes between 1% and 70% weight to weight and preferably 5% to 60% and even more preferably 10 to 50% weight to weight ratio of the dissolvable bleach sheet.

Any of the non-limiting embodiments herein may include: a builder agent such as but not limited to citrate, citric acid, sodium triphosphate, zeolite, carbonate, phosphonate, and lime, in the amount of 0 to 10%, or preferably 1 to 8% or even more preferably 2 to 7% weight to weight ratio of the dissolvable bleach sheet.

Any of the non-limiting embodiments herein may include: a chelating agent selected from the group consisting of EDTA, MGDA, DTPA, GLDA, and HEDP, or a combination thereof in the amount of 0 to 1% of the sheet.

Any of the non-limiting embodiments herein may include: a surfactant is selected from the group of anionic, nonionic or amphoteric surfactant or a mixture thereof.

Any of the non-limiting embodiments herein may include: a solubilizer selected from the group consisting of sodium carbonate, sodium phosphate, sodium bicarbonate, sodium pyrophosphate, sodium tripolyphosphate, sodium borate, sodium citrate, sodium silicate, sodium hydroxide, sodium sulfate, zeolite or a combination thereof.

Any of the non-limiting embodiments herein may include: wherein the bleaching agent is incorporated into a bleach sheet composition.

Any of the non-limiting embodiments herein may include: wherein the bleaching agent is incorporated in between one or more bleach sheets.

Any of the non-limiting embodiments herein may include: wherein the bleaching agent is dissolved in the bleach sheet composition.

Any of the non-limiting embodiments herein may include: wherein the bleaching agent is not dissolved in the bleach sheet composition.

Any of the non-limiting embodiments herein may include: wherein the bleaching agent dispersed in the bleach sheet composition.

Any of the non-limiting embodiments herein may include: wherein the pH of the bleach sheet is above pH 9 and preferably above pH of 10 and even more preferably above pH of 11.

Any of the non-limiting embodiments herein may include: a dispersing agent used to increase the solubility of the film forming composition during manufacturing.

Any of the non-limiting embodiments herein may include: a perfume or perfume micro-capsule or a combination thereof.

Any of the non-limiting embodiments herein may include: wherein the polymer is not soluble in water but is dispersible in water such as a cellulose based extract.

Any of the non-limiting embodiments herein may include: a dispersing agent selected from the group consisting of inorganic dispersant or organic dispersant or a combination thereof.

Any of the non-limiting embodiments herein may include: a dry particulate bleaching compound selected from the group consisting of sodium dichloroisocyanurate dihydrate, sodium dichloroisocyanurate, potassium dichloroisocyanurate dihydrate, potassium dichloroisocyanurate, sodium perborate monohydrate, sodium perborate tetrahydrate and sodium percarbonate or a combination thereof.

Any of the non-limiting embodiments herein may include: wherein the surfactant is selected from the group consisting of sodium lauryl sulfate, sodium dioctyl sulfosuccinate, linear alkyl benzene sulfonate, alpha olefin sulfonate, xylene sulfonate or a combination thereof.

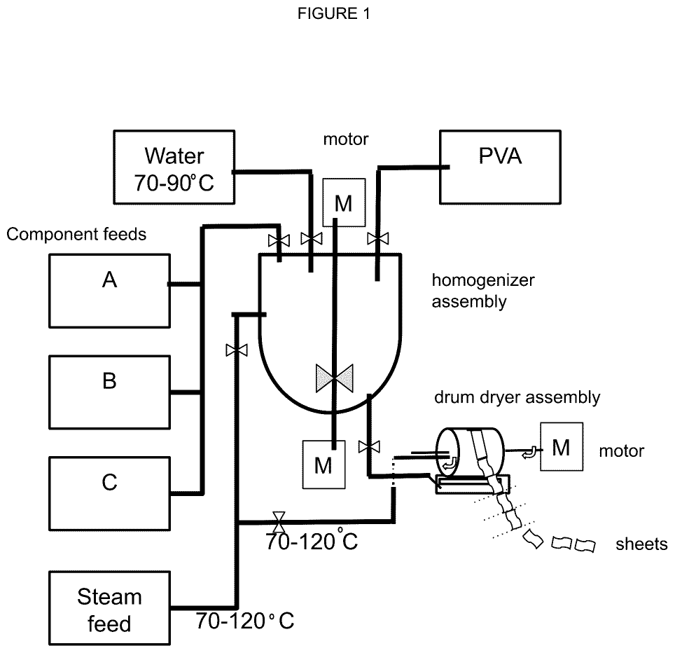

Referring now to the FIGURES, FIG. 1 is an illustration of a non-limiting embodiment of a homogenizer assembly, component feeds, and drum dryer assembly according to the invention. FIG. 1 shows water supply at 70-90° C. for delivery to the homogenizer tank via pumped delivery pipe with a control valve. The homogenizer tank includes a mixing paddle connected to electric motors. The PVA supply delivers polyvinyl alcohol to the homogenizer tank via pumped or gravity fed conduit for dissolving in the water. Component feeds A, B, C are delivered via pumped conduit to the homogenizer tank, and steam feed 70-120° C.

In the present invention the polyvinyl alcohol, water, bleaching agent, bleach activator, and pH modifier are mixed in a single homogenizer tank, and the homogenizer tank is heated using steam.

The PVA paste is pumped to the drum dryer assembly and delivered to a bottom feed tray having a bottom feed applicator roller disposed therein. The drum dryer comprises a heated drying drum having a drive system and a mirror finish, said drying drum mounted over a bottom applicator roller assembly having a bottom feed tray with a bottom feed applicator roller disposed therein, the bottom fed tray having a inlet for receiving the paste, the bottom feed applicator roller in operative contact with paste in the bottom feed tray, wherein rotational engagement between the drying drum and the bottom feed applicator roller forms a water dissolvable bleach sheet.

FIG. 1 also shows optional the optional step of trimming the water dissolvable bleach sheet to a form 1.5-2.0 mm thick, 50-127 mm wide, and 76-203 mm long.

In another non-limiting preferred embodiment, an additional step of surface spraying the water dissolvable bleach sheet with a surface agent selected from the group consisting of a bleaching agent, a bleach particle, a pH modifying agent, a bleach activator, a surfactant, a builder, a binding agent, a chelating agent, a fragrance, and a combination of one or more thereof.

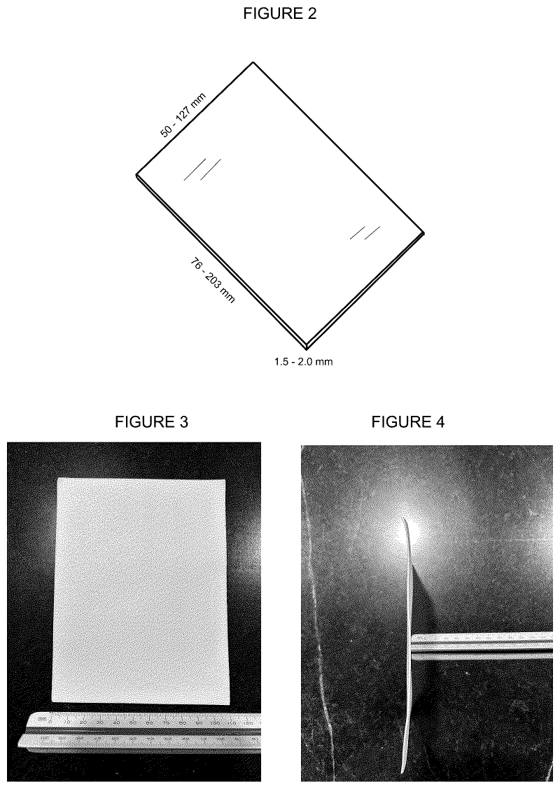

FIG. 2 is an illustration of a non-limiting embodiment in a perspective view showing the dimensions of a water dissolvable PVA sheet according to the invention.

FIG. 3 is a photo representation of a top view of a non-limiting embodiment showing ruler dimensions of a water dissolvable PVA sheet according to the invention.

FIG. 4 is a photo representation of a side view of a non-limiting embodiment showing ruler dimensions of a water dissolvable PVA sheet according to the invention.

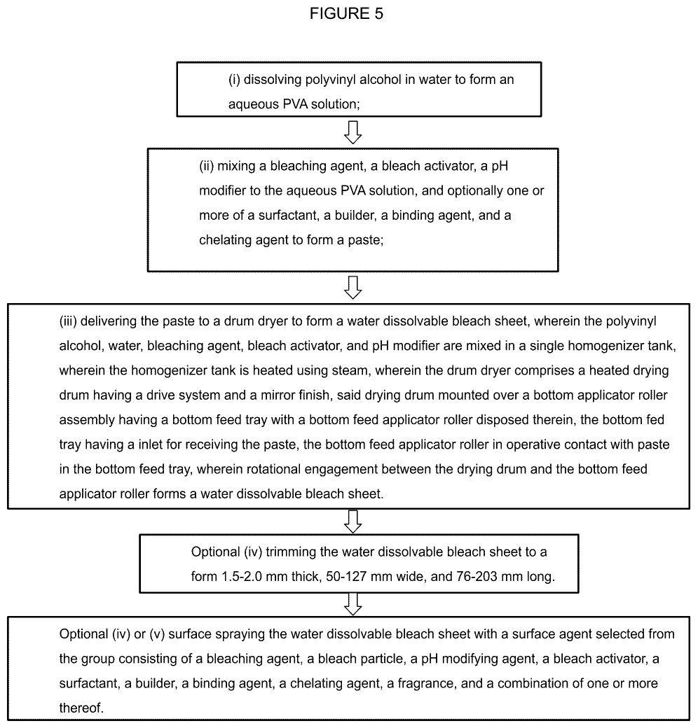

FIG. 5 is a flow chart illustration of a non-limiting embodiment of a method of manufacturing a water dissolvable PVA sheet using a homogenizer assembly, a supply for component feeds, and a drum dryer assembly according to the invention.

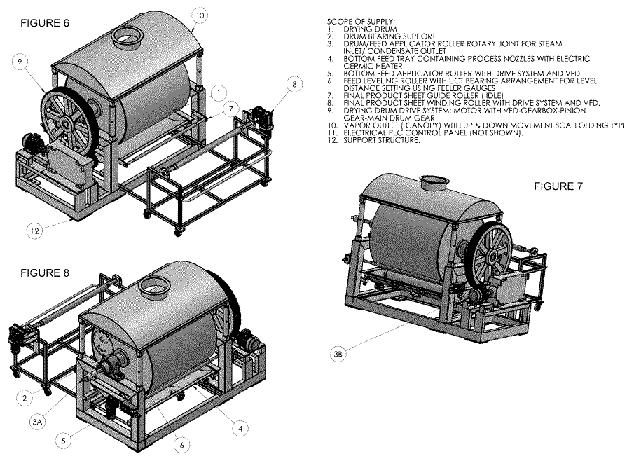

FIG. 6 is a perspective illustration of a non-limiting embodiment of a drum dryer assembly showing a drum drive and a sheet winding assembly. FIG. 6 shows drying drum gear system 9 with a motor having a variable frequency drive (VFD) gearbox pinion gear and main drum gear. FIG. 6 shows vapor outlet in canopy 10 with up/down movement scaffolding. Drying drum 1 is shown over the applicator try and adjacent to the final product sheet guide roller 7. Final product sheet winding roller assembly 8 with drive system and VFD is shown in position to receive the dried sheet.

FIG. 7 is a perspective illustration of a non-limiting embodiment of a drum dryer assembly showing a drum drive. FIG. 7 shows drum/feed applicator roller 3B with a rotary joint for a steam inlet and condensate outlet for the drum.

FIG. 8 is a perspective illustration of a non-limiting embodiment of a drum dryer assembly showing a drum drive and steam inlet. FIG. 8 shows drum bearing support 2. FIG. 8 also shows 3A rotary joint for a steam inlet for the drum. A bottom feed applicator roller 5 is shown having a drive system and VFD. A feed leveling roller 6 with a UCT bearing arrangement for level distance setting using feeler gauges is also shown. Bottom feed tray 4 is shown and contains nozzles with an electric ceramic heater.

FIG. 9 is an side view illustration of a non-limiting embodiment of a drum dryer assembly showing a drum drive, a steam inlet, and applicator roller tray.

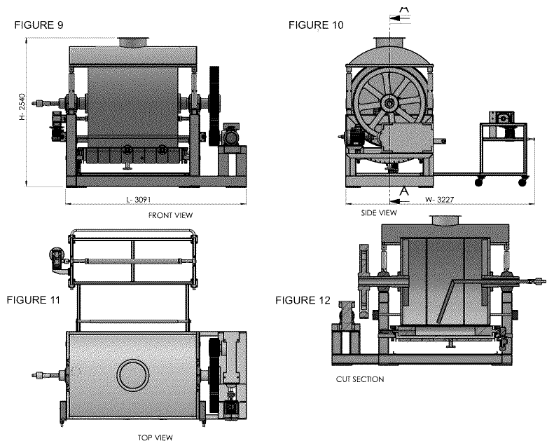

FIG. 10 is an end view illustration of a non-limiting embodiment of a drum dryer assembly showing a drum drive, motor, and sheet winding assembly.

FIG. 11 is a top view illustration of a non-limiting embodiment of a drum dryer assembly showing a drum drive, motor, and sheet winding assembly.

FIG. 12 is a cut-away view illustration of a non-limiting embodiment of a drum dryer assembly showing a drum drive, motor, dryer drum, roller tray, roller, and steam delivery conduit.

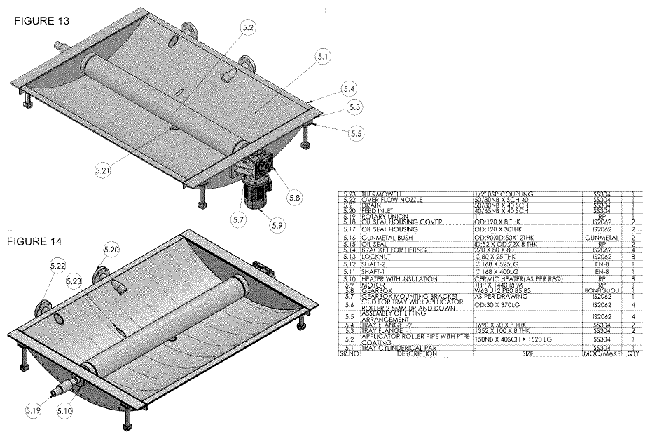

FIG. 13 is an perspective illustration of a non-limiting embodiment of an applicator roller tray, and roller assembly. FIG. 13 shows applicator roller pipe with PFTE coating 5.2 as part of the applicator tray. Drain 5.21 is shown at the bottom of the tray and roller motor is shown with 5.7 gearbox mounting bracket, 5.8 gearbox, and motor 5.9. Assembly lifting mechanism 5.5 is shown mounted on the tray lower surface.

FIG. 14 is an perspective illustration of a non-limiting embodiment of an applicator roller tray, and roller assembly. FIG. 14 shows overflow nozzle 5.22, drain 5.23, and feed inlet 5.20 for paste. Applicator tray also shows a heater unit 5.10.

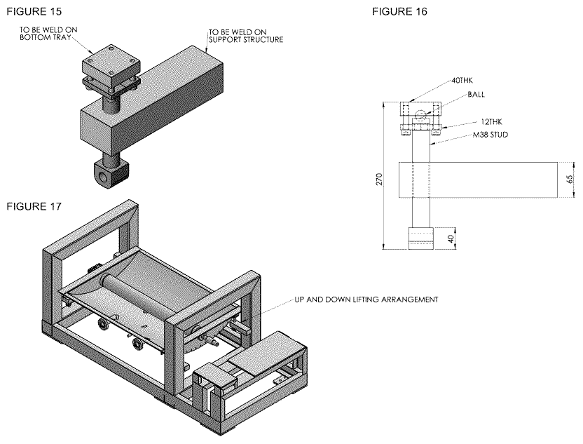

FIG. 15 is an perspective illustration of a non-limiting embodiment of a tray raising/lowering assembly.

FIG. 16 is a side view illustration of a non-limiting embodiment of a tray raising/lowering assembly.

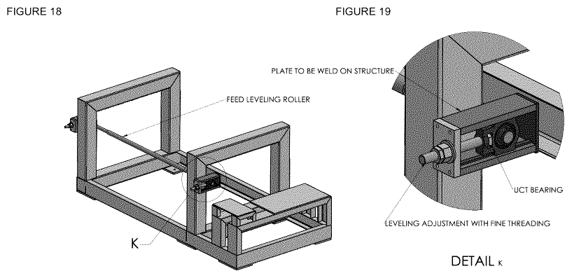

FIG. 17 is an perspective illustration of a non-limiting embodiment of an applicator tray, roller, and tray raising/lowering assembly.

FIG. 18 is an perspective illustration of a non-limiting embodiment of a (sheet) feed leveling roller assembly.

FIG. 19 is a detailed illustration of a non-limiting embodiment of a leveling adjustment mechanism for the (sheet) feed leveling roller assembly.

### Definitions

The term “film” as used herein may be understood to mean a thin and flexible membrane or layer. The thickness is not particularly limited. The shape of the film is not particularly limited.

The term “bleach sheet” as used herein may be understood as including a bleaching composition that is not activated in the film until said bleach sheet is being used and added to water to dissolve and/or disperse via its incorporation into a polymer film. Bleach sheets may include those formed by mixing a bleaching agent with a water dissolvable or water dispersible polymer film-forming composition. However, if the bleach granule is activated in a film-forming water dissolvable polymer or water dispersible during or after manufacturing of said bleach sheet, the composition becomes unstable and the active ingredient for bleaching may damage said bleach sheet. As a result, the problem associated with the stabilization of bleach in the bleach sheet composition and the manufacturing of said bleach sheet needs to be resolved for the ability to deliver the full effect of bleach in a dissolvable and/or dispersible bleach sheet.

The “film” may be formed by completely drying a solution for preparing a film or a bleach film or may be in a semi-dried state. When the film is in a semi-dry state, it may mean a state in which the film maintains the shape of the film while containing some moisture in the film. For example, it may mean a state in which the moisture of the solution for manufacturing the film or bleach film is evaporated by 70% or more, preferably 80% or more, and even more preferably 90% or more.

The term “sheet” as used herein refers to a film or bleach film in order to achieve the object of the present invention. The active ingredient for bleaching may mean preferably distributed in an undissolved state. The sheet of the present invention may include one bleach film and may be provided in the form of a single film or overlapping two or more films. When the sheet of the present invention includes two or more films, the bleaching composition may be incorporated between the two films. In another embodiment which consists of two or more films, at least one film is a bleach film.

The term “bleaching agent” is any ingredient or composition that produces bleach. It may be in the form or conventional chlorine such as sodium hypochlorite bleach or the ingredients that forms some type of strong oxidizing chorine based composition such as but not limited to sodium dichloroisocyanurate. Also said “bleaching agent” may be in the form of oxygen bleach such as peroxide or the products that upon dissolution in water form hydrogen peroxide, such as but not limited to sodium percarbonate and sodium perborate.

The term “dissolvable” or “soluble” as used wherein means that the composition, including the sheet, is soluble in water or somewhat soluble in water. Said soluble composition is preferably dissolved and solubilized homogenously in the water before the bleach sheet is made during production.

The term “dispersible” as used wherein means the composition, including the sheet may not dissolve and may not be fully soluble in the water or completely insoluble in water, but will disperse in water. Said dispersible composition is preferably dispersed homogeneously in the water before the bleach sheet is made during production.

The term “spherical” is a term including a shape that is not a perfect sphere shape. That is, the spherical cross section and/or the longitudinal section may be an ellipse rather than a perfect circle, and a regular or irregularly uneven shape is also included, not a smooth curved surface.

The term “not dissolved state” means that the ingredient is 100% not dissolved in the composition. It can be partially dissolved or completely not dissolved.

The term “bleach stable” is meant that these materials must be sufficiently stable in the presence of oxygen bleaches so that they retain their aesthetics, physical, and chemical property.

The term “builder” means a water softener which is capable of removing calcium and magnesium ions that are present in water.

The bleach sheets of the present invention comprise a bleach stable film-forming water dissolvable or water dispersible polymer film which results in said bleach sheet form.

An embodiment of the present invention comprises of a bleach sheet that is dissolvable or dispersible in water or other solvents. Said dissolvable or dispersible film is manufactured using bleaching components and a film-forming water dissolvable or water dispersible polymer, any one or more components selected from the group consisting of a bleach, a bleach activator and a pH modifier. These ingredients may be in a liquid form, a powder form, a granulated form or a combination thereof.

In a preferred embodiment, a dissolvable bleach sheet according to a preferred embodiment of the present invention, may be achieved by:
Preparing a solution to produce a bleach film by dissolving a film-forming water-dissolvable polymer that can form a sheet:
Further adding a bleaching agent;
Further adding a pH modifying agent that can raise the pH above 9, 10 or 11 to maximize oxygen bleach formation:
Further adding a bleach activator to form a peracid that is even more effective at bleaching than
oxygen bleach alone

In yet another preferred embodiment, a dispersible bleach sheet according to a preferred embodiment of the present invention, may be achieved by:
Preparing a solution for the production of a bleach film by dissolving a film-forming water-dispersible polymer that can form a sheet:
Further adding a bleaching agent; Further adding a pH modifying agent that can raise the pH above 9, 10 or 11 to maximize oxygen bleach formation:
Further adding a bleach activator to form a peracid that is even more effective at bleaching than oxygen bleach alone.

In another embodiment, during the film forming process the polymer chains aggregates and results in a film-forming water dissolvable or water dispersible polymer are released, and the active ingredients for bleach in a bleach form that is not dissolved between the polymer chains. Any one or more components selected from the group consisting of bleach activators can be added to increase the bleaching activity of the bleach sheet.

In another embodiment, the present invention provides a sheet which contains the bleaching composition. These materials comprising the sheet must be bleach stable, film-forming, water dissolvable or dispersible polymers. Many water dissolvable or water dispersible sheet forming materials are not suitable for use in the present invention since it is known that these compositions will cross-link in the presence of an oxidizing agent to form a sheet that does not dissolve or disperse in water after manufacturing of said bleach sheet. Furthermore, since it is preferred that the particulate bleaching materials must be maintained in a substantially dry state, the composition of the sheet must be capable to be extruded in the form of bleach sheets, after all components have been mixed during manufacturing. Water dispersible films may offer advantages of preventing the bleaching particle from being activated during manufacturing. Furthermore, the film composition may tolerate the bleaching agent and not affected by the oxidizing power of the bleach composition in the bleach sheet. The content of the bleaching compound in said bleach sheet may include a bleaching composition comprising of but not limited to sodium percarbonate or sodium perborate. Said bleaching compound may be coated to prevent interaction with the film of the bleach sheet. Furthermore, said bleaching may be incorporated into the film by dissolution or dispersion.

Suitable bleach stable water dissolvable or water dispersible film-forming polymers include but is not limited to PVA, Starch, Hydroxypropyl cellulose or other forms of cellulose. The composition of the bleach sheet should be sufficiently soluble in water or a non-aqueous solvent or should be sufficiently thermoplastic so that they can be formed into sheet form using known sheet forming methods such as extrusion. The compositions of the present invention can be formed by dissolving the bleach stable film-forming material in a suitable solvent such as methylene chloride, along with the bleaching agent. Another option is for the compositions of the present invention to be formed by dissolving the bleach stable film-forming material in an aqueous solvent such as water, along with the bleaching agent. The bleaching agent need not be soluble in the solvent but should be capable of being suspended along with the polymer. Other materials, such surfactants, may be added to improve the solubility or dispersibility if the bleach sheet. The film is then cast into sheet form and later cut up into the desired shape and size. If extrusion is to be utilized, it may not be possible to combine all the components of the present invention together at that time. In this method, the film-forming material may be extruded and the particulate bleaching composition, as well as other dry components may be dusted onto the hot surface of the film and adhere thereto. Alternatively, the above process can be utilized, and active bleaching agents can be covered with a second sheet of the same film-forming, water dissolvable or water dispersible polymer.

In another embodiment, the bleaching agent or the bleach activator or a combination thereof may be added in the form of granules in order to add it in an undissolved state. Any one or more components selected from the bleach or bleach activator may be added in a “non-dissolved state’, and the term “not dissolved state” means that the ingredient is 100% not dissolved in the composition.

In another embodiment, any one or more components selected from the group consisting of a bleach and a bleach activator may be added to the bleach film in an undissolved form, for example, in a granule form, which is then added to the bleach sheet. If it is contained in an undissolved form, the granules are not limited to any form.

In another embodiment, the film-forming water-soluble polymer used in the bleach sheet may be selected from natural, semi-synthetic, and synthetic polymers or a combination thereof. Natural polymers may include but are not limited to gelatin, pectin, dextran, starch, chitosan, guar gum, xanthan gum, soy polysaccharide, gellan gum, maltodextrin, rosin collagen, agar, gum arabic, gum acacia, gum karaya, guar gum, carrageenan, and the like can be used. Semi-synthetic polymers, may include but are not limited to methyl cellulose, ethyl cellulose, hydroxyethyl cellulose, hydropropyl cellulose, sodium carboxy methyl cellulose, dextrin, carboxy methyl starch, dialdehyde starch, and the like may be used. Synthetic polymers may include but are not limited to polyvinyl alcohol, polyvinyl pyrrolidone, polyvinyl methacrylate, polyacrylic acid and salts thereof, polyethylene oxide, carboxy-containing acrylic resin, carboxy-containing polyester resin, water-soluble polyamide, water-soluble polyurethane, maltodextrin, and polydextrose may be used.

A preferred example of the film-forming water-soluble polymer is polyvinyl alcohol (PVA) or PVA film (such as PVA film from Monosol or Kuraray).

The film-forming water dissolvable polymer may be included in 5 to 80% by weight based on the total weight of the film or the bleach film after drying, and preferably 7 to 50% by weight, more preferably 10 to 20% by weight. When the content of the water-soluble polymer is less than 5% by weight, the tensile strength of the bleach sheet is too weak to form a film or a bleach film. When it is more than 80% by weight, the content of the active ingredient is relatively small. There is a problem in that the function of the film or the bleach film is deteriorated or the content of the bleaching agent or the total bleach composition resulting from the bleach activator. The coating of said bleaching agent can reduce the issues associated with the deterioration of the bleach film or the resulting bleach sheet.

The film-forming water dispersible polymer may be included in 1 to 80% by weight based on the total weight of the film or the bleach film after drying, and preferably 2 to 50% by weight, more preferably 3 to 30% by weight. When the content of the water dispersible polymer is less than 5% by weight, the tensile strength of the bleach sheet is too weak to form a film or a bleach film. There is a problem in that the function of the film or the bleach film is deteriorated or the content of the bleaching agent or the total bleach composition resulting from the bleach activator. The coating of said bleaching agent can reduce the issues associated with the deterioration of the bleach film or the resulting bleach sheet.

The ‘water solubility’ of the film-forming water dissolvable polymer in the bleach sheet according to the present invention may be defined as the following measurement conditions. After adding a certain amount of film (e.g. 10 g) made of a film-forming polymer to 1 liter of water, stirring it on a magnetic stirrer set at a speed of 500 rpm for 10 minutes, and filtering the prepared film solution with a filter paper having a maximum pore size of 10 μm. Vacuum filtration may be needed to assist in the filtration process. Water is dried from the collected filtrate, and the weight of the residual material is measured. The residual weight is defined as a film-forming water-dissolvable polymer.

Film-forming water-dispersible polymers also belong to the category of film-forming polymers in the present invention. When the film forming substrate is not 100% soluble in water, this referred to as a dispersible film.

In this specification, the meaning of the term ‘water dispersibility’ is as follows. A certain amount of film (10 g) was added to 1 L of water, stirred for 10 minutes on a magnetic stirrer set at a speed of 500 rpm, and the water dispersion was filtered through a 10 μm pore filter, and the filtered filter was dried. When the weight change is less than about 100%, or preferably less than 90%, or more preferably less than 80% of the weight of the initial film, it is defined as a water-dispersible film-forming polymer.

The solvent used for preparing the bleach sheet according to the present invention comprises of water or a water based composition to dissolve the water-dissolvable polymer.

The solvent used for preparing the bleach sheet according to the present invention comprises of water or a water based composition to disperse the water-dispersible polymer.

In another embodiment the suitable bleach stable water dissolvable or water dispersible film forming polymers may be soluble in water or dispersible in water during manufacturing. In this embodiment, the bleaching composition may be soluble in water, partially soluble in water or insoluble in water. In this composition, the bleaching agent may be added during or after manufacturing the bleach sheet. Furthermore, the bleaching agent may be added by incorporating the bleach particles onto the bleach sheet by spraying, dusting or adding said bleaching agent directly onto the sheet or it may be incorporated in between two or more sheets.

It has also been found that the combination of nanocellulose and a dispersing agent is very helpful in aiding dissolution of the sheet in the wash liquor and furthermore readily dissolve and/or disperse after said bleach sheet as been dried during manufacturing. Suitable dispersing agents include compounds such as surfactants. Other ingredients include. Furthermore, these materials often are personal care products as builders and also increase the bleaching of the overall system.

In another embodiment the bleaching agent may use a bleach that results from the addition of an organic compound in water such as sodium dichloroisocyanurate dihydrate, sodium dichloroisocyanurate, potassium dichloroisocyanurate dihydrate, potassium dichloroisocyanurate, or a combination thereof.

In another embodiment, the bleaching agent may use a bleach that results from the addition of an inorganic bleaching agents such as perborate (for example sodium perborate), percarbonate (for example, soda percarbonate), superphosphate, persulfate, persulfate perhydrate salt containing a silicate or a combination thereof.

In another embodiment, the bleaching agent may use a bleach that results from the addition of an organic peroxy acid containing diacyl and tetraacyl peroxide or a combination thereof.

In a preferred embodiment, the pH modifier in the present invention may be an alkaline ingredient and preferably is a carbonate (for example sodium carbonate), an hydroxide (for example sodium hydroxide), a silicate (for example sodium silicate) or a combination thereof.

In another embodiment of the present invention the sheet comprises a pH modifying agent comprising but not limited to sodium carbonate, sodium bicarbonate, sodium hydroxide, sodium silicate or a combination thereof. Other pH modifiers that can raise the pH may be used. Its role is to increase the pH above 9, 10, or even above 11. At higher pH, the bleaching agent such as percarbonate or perborate or a combination thereof increases the amount of oxygen bleach in said composition.

In addition, the “bleach activator” in the present invention may be a bleach activator but is not limited to tetraacetylethylenediamine (TAED), benzoylcaprolactam (BzCL), 4-nitro Benzoylcaprolactam, 3-chlorobenzoylcaprolactam, benzoyloxybenzenesulfonate (BOBS), nonanoyloxybenzenesulfonate (NOBS), phenyl benzoate (PhBz), decanoyloxybenzenesulfonate (C 10-OBS), Benzoylvalerolactam (BZVL), octanoyloxybenzenesulfonate (C 8-OBS) and any one selected from the group consisting of perhydrolyzable esters, or a combination thereof may be used. In a preferred embodiment of the present invention a peracid formed by the addition of a bleach activator comprising of but not limited to NOBS or TAED or a combination thereof. Other bleach activators may be used to increase the peracid level of the bleach sheet.

In yet another embodiment a bleach and/or bleach activator is added in an undissolved form wherein most of the bleach and/or bleach activator is activated during actual bleaching, resulting in bleaching power compared to the case when added to a water dissolvable or water dispersible polymer solution.

Preferably, in the present invention, when any one or more components selected from the group consisting of bleach, bleach activators and pH modifier are added as granules, in order not to dissolve in the film or the bleach film. In another embodiment the bleach granules may be coated with an inert coating or an active coating consisting of the pH modifier. In yet another embodiment, the bleach granule may be coated with the bleach activator. In yet another embodiment, the bleach activator may be coated with an inert coating or an active coating consisting of the pH modifier.

In another embodiment, the granules or coated particles or a combination thereof are not limited to any form, that is, unless the component is dissolved in the manufactured bleach sheet, it is not limited to any form, and there is no particular limitation on its size. That is, the granule is a term that includes all those having irregular shapes and sizes, commonly referred to as particles, powders, granules, and the like.

In yet another embodiment, the granules are a set of amorphous particles that do not have a specific shape, and in the present specification, a number of granules having different sizes are represented as average particle diameters.

In another embodiment, the shape of the granules is not limited thereto, but may include, for example, a spherical type, a cylinder type, a splinter type, or a mixture of two or more types thereof.

As used herein, the term “average particle diameter” means a particle size measured using a laser particle size analyzer. For reference, when measuring the particle size distribution, the diameter of the particle is an imaginary equivalent diameter. When one of the physical properties of the measured particle is similar to that of a sphere with a specific diameter, this diameter is called the equivalent diameter of the measured particle. The laser particle size analyzer uses the scattering properties to make an equivalent contrast, and the measured diameter is the equivalent scattering diameter. That is, the diameter of a fuselage sphere having the same scattering characteristics as the measured diameter is used to indicate the actual particle size.

In another embodiment, the average particle diameter of the granules may be 1 to 2000 um, preferably 10 to 500 um, more preferably 50 to 250 um.

In yet another embodiment, ingredients that can be applied in the form of granules may include, but are not limited to, builders, bleach, bleach activators, pH modifiers, sterilization/disinfectants, and fragrances.

Therefore, any one or more components selected from the group consisting of the bleach, bleach activator, and pH modifier are added as granules, and if the granules are not dissolved after preparing a film or the bleach film, before drying, during drying or it can be added at any stage after drying.

A preferred composition for the bleach sheets consists of water dissolvable or dispersible film polymer, a bleaching agent, a pH modifying agent, and a bleach activator.

Another preferred composition of the present invention comprises of small amounts of materials such as a bleach stable perfume, or bleach stable perfume micro capsules or a combination thereof.

The bleach sheet compositions of the present invention can be prepared by a number of conventional sheet-forming methods. One method comprises of casting a film into a mold and once the solvent is dried, a bleach sheet composition has been manufactured. The solvent for said bleach sheet may comprise of a non-aqueous liquid during manufacturing, wherein said non aqueous liquid is removed during manufacturing.

Another method comprises of dissolving the film forming polymer in an aqueous solvent, wherein said aqueous liquid is removed during manufacturing.

Another method for preparing the sheets of the present invention comprises extruding the film-forming composition into a sheet. This extruded sheet can be the film-forming polymer itself. This extruded film is then contacted with the dry bleaching agent.

Another method for preparing said bleach sheet is to dissolve or disperse the bleaching composition into one or more sheet of film forming material.

Another method for preparing said bleach sheet is to place the dry bleaching composition between one of more sheets of film-forming material.

In another embodiment of the present invention, the bleach sheet may be manufactured by further comprising the step of further stacking the bleach film. After the distribution of an undissolved component of any one or more components selected from the group consisting of a film former, a pH modifier, a bleaching agent and a bleaching activator on one or both sides of the film, a bleach film is additionally added. It may include the step of laminating. The additionally laminated bleach film may be replaced with a film or a bleach film or a combination thereof.

In yet another embodiment of the present invention, the step of adhering two films may be stacked by stacking each other or may be adhered after overlapping. Bonding may mean a form in which two sheets of films are attached to each other, and may be attached using an adhesive, heat, or ultrasonic waves, but the method of attaching is not particularly limited. The method of attaching the film to the film is particularly limited as long as it is possible to adhere the film so that any one or more components selected from the group consisting of bleach and bleach activators are present in an undissolved form between the film and the film.

An embodiment of the present invention provides a bleach sheet manufactured by the method of manufacturing a bleach sheet of the present invention.

Preferably, the manufacturing method may include a drying step, and the reaction conditions of the drying step vary depending on the process conditions and may consist of a drying drum. The temperature of the drying drum is 40 to 130° C., the drying time is 5 to 30 minutes, and the drying speed is 1 to 10 m/min of bleach sheet, and preferably the temperature of the drying furnace may be 60 to 120° C., and more preferably the drying temperature may be 70 to 110° C. and more preferably 80 to 100° C.

In another embodiment, a detergent component may be added to the bleach sheet composition. A generally widely used anionic surfactant, a nonionic surfactant, or an amphoteric surfactant, or a combination thereof may be mixed. It has been found that the inclusion of a small amount of surfactant into the composition aids in the dissolution of the sheet during the wash cycle. Suitable surfactants should be compatible with the other components of the composition of the present invention and should be stable in the presence of bleaching agents. The anionic surfactant may include but is not limited to carboxylate compounds such as soap, higher alcohols, higher alkyl esters, sulfuric ester salt compounds obtained by sulfated olefins, alkylbenzene sulfonates, and sulfate compounds including lauryl sulfate salts or a combination thereof. Key surfactants include but are not limited to Linear Alkyl Benzene Sulfonate (LAS), Sodium Lauryl Sulfate (SLS), Sodium Laureth Sulfate (SLES), Ammonium Lauryl Sulfate (ALS), Alcohol Ethoxylate (AE), Alcohol Ethoxysulfate (AES), Fatty Acid, Sodium Dodecyl Sulfate (SDS), Secondary Alkane Sulfonate (SAS), Methyl Ester Sulfonate, etc or a combination thereof.

In addition, the nonionic surfactant may include but is not limited to polyoxyalkylene alkyl phenyl ether, polyoxyalkylene alkyl ether, polyoxyethylene polyoxypropylene block polymer, polyethylene glycol fatty acid ester, polyoxyethylene sorbitan fatty acid Esters, cocamido monomethylamine, cocamido dimethylamine, cocamido monoethylamine, fatty acid alkanolamine, amine oxide, alkyl polyglucoside, methyl polyethylene alkyl ether (methyl polyethylene alkyl ether) or sugar ether, and these may be used alone or a combination thereof. Preferably the nonionic is natural and not limited to yucca, saponin, coco glucoside, coco betaine, capryl glucoside, lauryl glucoside, or decyl glucoside or a combination thereof.

In addition, the amphoteric surfactant may include but is not limited to amine-oxide, Cocamidopropyl Betaine, Coco Betaine or a combination thereof.

On the other hand, active ingredients for bleach, such as bleach, and bleach activators, are ingredients that react with water to express an effect and exhibit an effect of bleaching and are prepared by mixing with a film-forming water-soluble polymer or a film-forming water-dispersible sheet. As it dissolves in the process, its activity is expressed, and results in a bleaching effect that may decrease the solubility or dispersibility of the bleach sheet.

Therefore, in order to solve the problem of deteriorating the performance of the bleach sheet that exhibits an effect by reacting with water in a water dissolvable polymer film or water dispersible film, an active ingredient for bleach prepared in the form of granules or coated bleaching agent and is applied to the composition for manufacturing a bleach sheet. That is, in the present invention, the active ingredient for bleaching prepared in the form of granules is mixed in a non-dissolved form between polymer chains of the bleach sheet or using encapsulated bleaching agent with an encapsulating composition that minimizes the degradation of the bleaching agent.

That is, in the present invention, in a bleach sheet manufactured using a bleaching component and a film-forming water-dissolvable polymer or a water dispersible polymer, any one or more components selected from the group consisting of a builder, a bleach, and a bleach activator wherein their composition are granulated or encapsulated. It provides a bleach sheet, that is tolerant to the aggressive nature of the bleaching agent.

Preferably, in the present invention, when any one or more components selected from the group consisting of bleach, bleach activators and pH modifiers are added as granules or coated particles or a combination thereof, in order not to dissolve or disperse the film, the bleaching ingredients may not be dissolved and may not be activated before washing. The moisture content is not limited to, but preferably may be about 20% by weight or less based on the total weight of the film, and preferably 10% by weight or less based on the total weight of the film.

When the ingredients are mixed with a water dissolvable polymer or water dispersible solution when manufacturing a bleach sheet, their activity is expressed in the manufacturing process of the
bleach sheet, and thus the performance cannot be exhibited when an actual product is used. And/or when separately added in a form that is not dissolved in the composition for manufacturing a bleach sheet, it was found that the performance of the above components can be fully exhibited, and the present invention was completed.

In another embodiment, a builder component may be added to the bleach sheet composition. The term “builder” means a water softener. The builder is not limited to but refers to a substance that acts such as precipitating calcium or magnesium in hard water, removing it by ion exchange, or forming a chelate to block its function as an ion. That is, the builder is activated by reacting with water to express the above effect. The builder usable in the present invention may preferably be an alkali builder, but is not limited to sodium hydroxide, sodium carbonate, sodium hydrogen carbonate, sodium metasilicate, sodium alkali silicate, sodium neutral silicate, sodium tripolyphosphate, sodium pyrophosphate, Sodium borate, zeolite (sodium aluminosilicate), MEA (monoethanolamine, monoethanolamine), and TEA (triethanolamine, triethanolamine). It may be any one selected from the group consisting of, or a combination thereof.

In general, when a builder is added to a water dissolvable polymer solution in powder form during the manufacturing process of a bleach sheet, as in the prior art, the builder is activated during
the sheet manufacturing process by water contained in the water dissolvable or water dispersible polymer solution, thereby exerting a full effect during actual washing. It is difficult to do, and in the case of PVA, it is difficult to form a sheet due to gelation or salting out by reaction, and solubility may be deteriorated due to the bleaching agent. In order to solve this problem, the present invention uses a coating process to encapsulate the bleaching agent and thus prevent the immediate bleaching activation process. Said coating may comprise of the builder. In yet another embodiment, the bleaching agent doesn't react negatively with the non-water dissolvable film and the water dispersible film is not affected by the bleaching agent and the resulting bleaching composition.

In another embodiment, the “sterilization/disinfectant” may use components that can be generally used during bleaching, and is not limited thereto, but is not limited to sodium hypochlorite, hydrogen peroxide, urea peroxide, sodium diisocyanate (NaCl 3 (CON) 3), Potassium sulfate ((KHSO 5) 2 KHSO 4 K 2 SO 4), calcium peroxide, sodium tripolyphosphate, sodium acid pyrophosphate, and the like can be used. When the component is prepared in the form of granules, it may be prepared in the form of granules by mixing a single component or two or more components.

In another embodiment, a fabric softener, a dispersant, an emulsifier, etc. may be additionally added to the bleach sheet.

More specifically, the bleach sheet according to the present invention may use a quaternary ammonium salt-based cationic surfactant as a fabric softener. For example, dialkyl dimethyl ammonium chloride, alkyl imidazolinium salt, dialkylamido quaternary ammonium salt and ester quat type, or a combination thereof may be added to the bleach sheet.

In another embodiment, natural or synthetic cationic polymers may be used as the fabric softener component. For example, but not limited to, cationic guar such as guar hydroxypropyltrimonium chloride, hydroxypropyl guar hydroxypropyltrimonium chloride, cellulose (polyquaternium-10), polyquaternium series, dimethyl diallyl Ammonium chloride polymer, acrylamide-dimethyldiallylammonium copolymer, polyvinylpyrrolidone (PVP)-dimethylaminoethyl methacrylate copolymer, acrylic acid-dimethyldiallylammonium chloride copolymer, acrylamide-dimethylamino ethylmethacryl methyl chloride copolymer, a trimethylaminoethyl methacrylate polymer, or a combination thereof may be added to the bleach sheet.

In another embodiment, a dispersant may be contained in the bleach sheet of the present invention. For example, a dispersant helps to uniformly mix a water-dissolvable polymer or stabilize a water dispersible polymer and an active ingredient such as a cationic surfactant, and the dispersant helps the water dispersibility of the active ingredient for bleaching when the film is dissolved or dispersed in water.

The bleach sheet according to the present invention may use a nonionic surfactant as an emulsifier. For example, polyoxyalkylene alkyl phenyl ether, polyoxyalkylene alkyl ether, polyoxyethylene polyoxypropylene polymer, polyethylene glycol fatty acid ester, polyoxyethylene sorbitan fatty acid ester, or a combination thereof may be added to the bleach sheet.

The content of the emulsifier may be 0 to 40% by weight based on the total weight of the film after drying, preferably 1 to 20% by weight, more preferably 1 to 10% by weight.

The bleach sheet according to the present invention may be used by adding a bleach stable fragrance, a preservative, a stabilizer, a colorant or an antibacterial agent or a combination thereof in addition to the above components.

The thickness of the bleach sheet according to the present invention is preferably 1 mm to 10 mm, and more preferably 1.5 mm to 7 mm and even more preferably 2 mm to 5 mm. If the thickness of the dried bleach sheet is less than 1 mm, the active ingredient will be insufficient to produce enough bleaching using said bleach sheet. If the thickness of the dried bleach sheet exceeds 10 mm, the fast dissolution or fast dispersion properties will be reduced.

The bleach sheet according to the present invention completely dissolves or completely disperses in water after the use is completed, and there is no need to remove the bleach sheet separately. That is, the water dissolvable polymer or the water dispersible polymer forming the matrix of the bleach sheet is dissolved or dispersed completely in water.

In another embodiment, a bleach sheet having a multilayer structure in which one or more films or bleach films are stacked to form a multilayer structure.

In another embodiment, there is provided a bleach sheet in which a film is prepared by using a film-forming water-dissolvable polymer or a film forming water dispersible film which is additionally laminated on one or both sides of the bleach sheet.

The film-forming water-dissolvable or water dispersible polymer in which the active ingredient for bleaching is distributed between the polymer chains prepared according to the present invention is solidified in a film form, and in particular, from the group consisting of a bleach, a pH modifier, and a bleach activator prepared in a granular form. The bleach sheet containing any one or more selected ingredients provides excellent bleaching performance in the sheet form.

The present invention also relates to a method of making a film containing a water soluble composition of polyvinyl alcohol (PVA), which is processed and may be extruded to produce filaments or fibers by converting the filaments and/or fibers and/or nonwoven webs into films. In another embodiment, the PVA is casted and formed into a film. Casting processes for making films, particularly water-soluble films, and/or films comprising water-soluble film forming materials (eg, polyvinyl alcohol) are known in the art. Such casting processes use a solvent and a solution of a film-forming material such as polyvinyl alcohol, which is deposited on and/or flowed over a casting surface such as a metal wheel, roller or belt. The solvent is then removed from the solution, for example by drying. Once the solvent is removed from the solution, a film formed from the filament forming material remains on the casting surface. The casting process for making films is known to be very time intensive since the solvent needs to be removed by drying. As used herein, “filament” means an elongated microparticle having a length that greatly exceeds its diameter, ie, a ratio of length to diameter of at least about 10.

The filaments of the present invention can be spun from the filament forming composition via suitable spinning process operations, such as melt blowing and/or spun bonding. The filaments of the present invention may be single component and/or multicomponent. For example, the filament may comprise a bicomponent filament. The bicomponent filament may be in any form such as side-by-side, core and sheath, or sea-island type. The filaments of the present invention are 2 inches or more, and 3 inches or more, and 4 inches or more, and 6 inches or more.

As used herein, an additive may include a plasticizer. Non-limiting examples of suitable plasticizers of the present invention include polyols, copolyols, polycarboxylic acids, polyesters, and dimethicone copolyols. Examples of useful polyols include glycerin, diglycerin, propylene glycol, ethylene glycol, butylene glycol, pentylene glycol, cyclohexanedimethanol, hexanediol, 2,2,4-trimethylpentane-1,3-diol, polyethylene glycol (200-600), sugar alcohols such as pentaerythritol, sorbitol, mannitol, lactitol and other mono- and polyhydric low molecular weight alcohols (eg C2-C8 alcohols); mono, di- and oligosaccharides such as fructose, Examples include, but are not limited to, glucose, sucrose, maltose, lactose, and higher fructose corn syrup solids, and dextrin, and ascorbic acid. In yet another example, the plasticizer includes glycerin and/or propylene glycol, and/or a glycerol derivative, such as propoxylated glycerol. In yet another embodiment, the plasticizer is selected from the group consisting of glycerin, ethylene glycol, polyethylene glycol, propylene glycol, glycidol, urea, sorbitol, xylitol, maltitol, saccharides, ethylene bisformamide, amino acids, and mixtures thereof. Is done.

As used herein, an additive may include a crosslinking agent suitable for crosslinking one or more filament-forming materials present in the filaments of the present invention. In one example, the cross-linking agent includes a cross-linking agent that can cross-link the hydroxyl polymer together, for example, via the hydroxyl portion of the hydroxyl polymer. Non-limiting examples of suitable crosslinkers include imidazolidinone, polycarboxylic acids, and mixtures thereof. In one example, the cross-linking agent comprises a urea glyoxal adduct cross-linking agent, for example, a dihydroxy imidazolidinone such as dihydroxyethylene urea (“DHEU”). Crosslinking agents may be present in the filament forming composition of the present invention and/or in the filaments to control the solubility and/or dissolution of the filaments in a solvent such as a polar solvent.

As used herein, an additive may include a rheology modifier such as a shear force modifier and/or an extension modifier.

As used herein, an additive may include a visual signal agent wherein the additive may be used when the filament is exposed to the intended application conditions and/or when the active agent is released from the filament and/or when the morphology of the filament changes. To provide a visual signal, it includes one or more colors and/or dyes incorporated into the filaments of the present invention.

As used herein, an additive may include one or more release agents and/or lubricants. Non-limiting examples of suitable release agents and/or lubricants include fatty acids, fatty acid salts, fatty alcohols, aliphatic esters, sulfonated fatty acid esters, aliphatic amine acetates, fatty acid amides, silicones, aminosilicones, fluoropolymers, and mixtures thereof.

As used herein, the naturally occurring starch is generally consisting of a mixture of linear amylose and branched amylopectin polymers of D glucose units. Amylose is essentially a linear polymer of D-glucose linked by (1,4)-α-D bonds. Aminopectin is a highly branched polymer of (1,4)-α-D bonds and (1,6)-α-D-glucose units at branch points. Naturally occurring starch is typically a relatively high concentration of amylopectin, such as corn starch (64-80% amylopectin), waxy maize (93-100% amylopectin), rice (83-84% amylopectin), potato (About 78% amylopectin) and wheat (73-83% amylopectin). Although all starches are potentially useful herein, the present invention is most commonly practiced with high amylopectin natural starch derived from agricultural sources, which is an abundant source and can be easily supplemented and offers the advantage of being inexpensive.

As used herein, the “starch” includes any naturally occurring unmodified starch, modified starch, synthetic starch, and mixtures thereof, and mixtures of amylose or amylopectin fractions, It may be modified by chemical, chemical, or biological processes, or combinations thereof.

As used herein, the starch or starch mixture useful in the present invention is from about 20% to about 100%, more typically from about 40% to about 90%, even more typically. Having an amylopectin content from about 60 wt % to about 85 wt % starch or mixtures thereof.

As used herein, suitable starches of natural origin include: corn starch, potato starch, sweet potato starch, wheat starch, sago palm starch, tapioca starch, rice starch, soybean starch, arrow root starch, amino starch, bracken starch, lotus starch, Non-limiting examples include waxy corn starch and high amylose corn starch. Naturally occurring starches, particularly corn starch and wheat starch, are preferred starch polymers due to their economics and availability.

As used herein, non-limiting examples of suitable surfactants include anionic surfactants, or cationic surfactants, or nonionic surfactants, or zwitterionic surfactants, or amphoteric surfactants, or a combination thereof. A co-surfactant may also be included in the filament. For example, for filaments designed for delivering cleaning benefits, the total surfactant concentration should be sufficient to provide cleaning including stain and/or odor removal, generally, in the range of about 0.5% to about 95%. In addition, surfactant systems comprising two or more surfactants designed for use in the bleach filaments are fully anionic surfactant systems, or a combination of two or more different anionic surfactants, or a mixture of different types of surfactant system, or a combination thereof.

As used herein, a surfactant or a combination of surfactants may be linear or branched surfactants. As used herein suitable linear surfactants include those derived from agricultural chemical oils, such as coconut oil, palm kernel oil, soybean oil, or other vegetable oils.

As used herein, the suitable anionic surfactants may include alkyl sulfates, alkyl ether sulfates, branched alkyl sulfates, branched alkyl alkoxylates, branched alkoxylate sulfates, medium chain branched alkyl allyl sulfonate, sulfated monoglyceride, sulfonated olefin, alkyl allyl sulfonate, primary or secondary alkane sulfonate, alkyl sulfosuccinate, acyl taurate, acyl isethionate, alkyl glyceryl ether sulfonate, sulfonated methyl ester, sulfonated fatty acid, alkyl phosphate, acyl glutamate, acrylic sarcosinate, alkyl sulfoacetate, acylated peptide, alkyl ether carboxylate, anionic fluorosurfactants, sodium lauroyl glutamate, or a combinations thereof.

As used herein, the suitable alkyl sulfates and alkyl ether sulfates for use herein include materials having the corresponding formulas ROSO₃ M and RO (C₂ H₄ O)ₓ SO₃ M, wherein R Is an alkyl or alkenyl from about 8 to about 24 carbon atoms, x is 1-10, and M is a water-soluble cation such as ammonium, sodium, potassium, and triethanolamine. Other suitable anionic surfactants are MacCutcheon's “Detergents and Emulsifiers” (North American Edition (1986), Allred Publishing Corp.) and Mccutcheon's “Functional Materials 92” (Natural Publishing Corp.).

As used herein, anionic surfactants useful in the filaments of the present invention, C₉-C₁₅ alkyl benzene sulfonates (LAS), C₈-C₂₀ alkyl ether sulfates, such as alkyl poly (ethoxy) sulfates, C₈˜C₂₀ alkyl sulfates, and mixtures thereof. Other anionic surfactants may include methyl ester sulfonate (MES), methyl ester etchelate (MEE), sulfonated estolides, and mixtures thereof.

As used herein, the anionic surfactant is a C₁₁-C₁₈ alkyl benzene sulfonate (“LAS”) and primary branched chain, and a random C₁₀-C₂₀ alkyl sulfate (“AS”), formula CH₃(CH₂) x CHOSO₃-M+) CH₃ and CH₃(CH₂)_{y}(CHOSO₃-M+) C₁₀˜C₁₈ secondary of CH₂ CH₃ (2,3) alkyl sulfates (formula In which x and (y+1) are integers of at least about 7, preferably about 9, and M is a water-solubilizing cation, in particular sodium, an unsaturated sulfate such as oleyl sulfate), C₁₀-C₁₈ α-sulfonated fatty acid esters, C₁₀-C₁₈ sulfated alkyl polyglycosides, C₁₀-C₁₈ alkyl alkoxy sulfates (“AEₓ S”) (the formula x is 1 to 30), and C₁₀-C₁₈ alkyl alkoxy Ruboxylates (eg containing 1-5 ethoxy units), medium chain branched alkyl sulfates as described in U.S. Pat. Nos. 6,020,303 and 6,060,443; U.S. Pat. No. 6,008, medium chain branched alkyl alkoxy sulfates (MLAS) as described in 181 and 6,020,303; as described in WO 99/05243, WO 99/05242, and WO 99/05244 Modified alkylbenzene sulfonate (MILAS); methyl ester sulfonate (MES); and alpha-olefin sulfonate (AOS).

As used herein, other suitable anionic surfactants that can be used are alkyl ester sulfonate surfactants, including sulfonated linear esters of C₈ to C₂₀ carboxylic acids (ie fatty acids). The Other suitable anionic surfactants that can be used salts of soap, C₈-C₂₂ primary or secondary alkane sulfonates (primary of secondary alkanesulfonates), C₈˜C₂₄ olefin sulfonates, sulfonated polycarboxylic acids, C₈-C₂₄ alkyl polyglycol ether sulfates (alkylpolyglycolethersulfates) (contain ethylene oxide up to 10 moles); alkyl glycerol sulfonates, fatty acyl glycerol sulfonates, fatty oleoyl glycerol sulfates, alkyl phenol ethylene oxide ether sulfates, paraffin sulfonates, alkyl phosphates, isethionates, eg acyl isethionates, N-acyl taurates, alkyl succinates and sulfosuccinates, monoesters of sulfosuccinates (e.g. saturated and unsaturated C₁₂-C₁₈ monoesters) monoester, diester sulfosuccinates (e.g., saturated and unsaturated C₆-C₁₂ diesters), and alkyl polysaccharide sulfates, such as alkyl polysaccharides sulfates, and alkyl polyethoxy carboxylates such as those of the formula RO(CH₂CH₂O) k-CH₂ COO-M+ (wherein R is a C₈-C₂₂ alkyl, k is an integer of 0, M is a soluble salt-forming cation).

As used herein, other suitable anionic surfactants are alkyl benzene sulphonic acid of C₁₀-C₁₆, preferably an alkali metal salt of alkylbenzene sulfonic acid C₁₁-C₁₄.

As used herein, the suitable anionic surfactants are linear alkyl group is linear such as alkyl benzene sulfonates are known as “LAS”. Such surfactants and their preparation are described, for example, in U.S. Pat. Nos. 2,220,099 and 2,477,383. In other examples, linear alkyl sulfonate or linear alkylbenzene sulfonate or liner alkyl benzene sulfonate.

### Terminology

The terminology used herein is for the purpose of describing particular embodiments only and is not intended to limit the full scope of the claims. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention.

As used herein, the singular forms “a”, “an” and “the” are intended to include the plural forms as well, unless the context clearly indicates otherwise. With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” etc.). Similarly, the terms “comprises” and/or “comprising,” when used in this specification, specify the presence of stated features, integers (or fractions thereof), steps, operations, elements, and/or components, but do not preclude the presence or addition of one or more other features, integers (or fractions thereof), steps, operations, elements, components, and/or groups thereof. As used in this document, the term “comprising” means “including, but not limited to.”

As used herein the term “and/or” includes any and all combinations of one or more of the associated listed items. It should be understood that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

All ranges disclosed herein also encompass any and all possible subranges and combinations of subranges thereof unless expressly stated otherwise. Any listed range should be recognized as sufficiently describing and enabling the same range being broken down into at least equal subparts unless expressly stated otherwise. As will be understood by one skilled in the art, a range includes each individual member.

### EQUIVALENTS

Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

While various embodiments have been described above, it should be understood that they have been presented by way of example only, and not limitation. Where methods described above indicate certain events occurring in certain order, the ordering of certain events may be modified. Additionally, certain of the events may be performed concurrently in a parallel process when possible, as well as performed sequentially as described above.

Where schematics and/or embodiments described above indicate certain components arranged in certain orientations or positions, the arrangement of components may be modified. While the embodiments have been particularly shown and described, it will be understood that various changes in form and details may be made. Any portion of the apparatus and/or methods described herein may be combined in any combination, except mutually exclusive combinations.

The embodiments described herein can include various combinations and/or sub-combinations of the functions, components, and/or features of the different embodiments described. Various of the above-disclosed and other features and functions, or alternatives thereof, may be combined into many other different systems or applications. Various presently unforeseen or unanticipated alternatives, modifications, variations, or improvements therein may be subsequently made by those skilled in the art, each of which is also intended to be encompassed by the disclosed embodiments.

What is claimed as the invention:

1. A bleach composition in the form of a drum-dried water soluble sheet, comprising: a water dissolvable polymer film having a bleaching agent, a bleach activator, a pH modifier, and water 1-5% by weight, wherein the polymer is 10-20% by weight selected from the group consisting of polyvinyl alcohol, starch, and hydroxypropylcellulose, wherein the bleaching agent is 1-60% by weight, wherein the bleach activator is 1-40% by weight, wherein the pH modifier is 1-70% by weight, wherein all percentages total 100.

2. The bleach composition according to claim 1, wherein the polymer is polyvinyl alcohol.

3. The bleach composition according to claim 1, wherein the bleaching agent is selected from the group consisting of sodium hypochlorite, sodium percarbonate, and sodium perborate.

4. The bleach composition according to claim 1, wherein the bleach activator is selected from the group consisting of nonanoyloxybenzenesulfonate (NOBS), tetraacetylethylenediamine (TAED), lauryloxybenzenesulfonate (SDBS), benzoylcaprolactam (BzCL), 4-nitro Benzoylcaprolactam, 3-chlorobenzoylcaprolactam, benzoyloxybenzenesulfonate (BOBS), nonanoyloxybenzenesulfonate (NOBS), phenyl benzoate (PhBz), decanoyloxybenzenesulfonate (C 10-OBS), Benzoylvalerolactam (BZVL), octanoyloxybenzenesulfonate (C 8-OBS), a perhydrolyzable ester, and a combination thereof.

5. The bleach composition according to claim 1, wherein the pH modifying is selected from the group consisting of sodium carbonate, sodium bicarbonate, sodium hydroxide, sodium silicate and a combination thereof.

6. The bleach composition according to claim 1, wherein the bleaching agent is an encapsulated dry particulate bleaching agent.

7. The bleach composition according to claim 1, wherein the bleaching agent is an encapsulated dry particulate bleaching agent, and the bleaching agent is selected from the group consisting of sodium hypochlorite, sodium percarbonate, and sodium perborate, sodium dichloroisocyanurate dihydrate, sodium dichloroisocyanurate, potassium dichloroisocyanurate dihydrate, potassium dichloroisocyanurate, sodium perborate monohydrate, sodium perborate tetrahydrate and a combination thereof.

8. The bleach composition according to claim 1, wherein the bleaching agent is an encapsulated dry particulate bleaching agent, and the bleaching agent is selected from the group consisting of sodium hypochlorite, sodium percarbonate, and sodium perborate, sodium dichloroisocyanurate dihydrate, sodium dichloroisocyanurate, potassium dichloroisocyanurate dihydrate, potassium dichloroisocyanurate, sodium perborate monohydrate, sodium perborate tetrahydrate and a combination thereof, and wherein the encapsulant is selected from the group consisting of sulfate, carbonate, carbohydrate, starch, maltodextrin dextrin, sucrose, cellulose, agar, carrageenan, wax, paraffin, diglyceride, gluten, casein, albumin, peptide, sodium alginate, gum arabic, chitosan, carboxymethylcellulose, pectin, shellac, and a combination thereof.

9. The bleach composition according to claim 1, further comprising a surfactant selected from the group consisting of sodium lauryl sulfate, sodium dioctyl sulfosuccinate, linear alkyl benzene sulfonate, alpha olefin sulfonate, xylene sulfonate and a combination thereof.

10. The bleach composition according to claim 1, further comprising glycerin 1 to 10% by weight.

11. The bleach composition according to claim 1, further comprising a builder agent selected from the group consisting of citrate, citric acid, trisodium phosphate, zeolite, carbonate, phosphonate, and lime, in the amount of 1 to 10% by weight.

12. The bleach composition according to claim 1, further comprising a chelating agent selected from the group consisting of EDTA, MGDA, DTPA, GLDA, and HEDP, and a combination thereof 0.1 to 1% by weight.

13. The bleach composition according to claim 1, further comprising a fabric softener.

14. The bleach composition according to claim 1, wherein starch is 10-60% by weight, said starch selected from the group consisting of corn, wheat, potato, rice, or tapioca starch

15. and a combination thereof.

16. The sheet according to claim 1, wherein the sheet comprises a perforated weakened tear-line.

17. The sheet according to claim 1, wherein the sheet comprises one or more layers, and where the layers are the same or a different composition.

18. The sheet according to claim 1, wherein said polyvinyl alcohol film includes a water dissolvable co-polymer of ethylene oxide, or a water dissolvable co-polymer of propylene oxide or a combination thereof.

19. The sheet according to claim 1, include: a surfactant such as an anionic surfactant, a cationic surfactant, a nonionic surfactant or a amphoteric surfactant or a combination thereof, and a binding agent, wherein the polyvinyl alcohol, surfactant, binding agent, water, or a combination thereof, are mixed and dried to form the water dissolvable bleach sheet.

20. A method for producing a water dissolvable bleach sheet, the steps comprising: (i) dissolving polyvinyl alcohol in water to form an aqueous PVA solution; (ii) mixing a bleaching agent, a bleach activator, a pH modifier to the aqueous PVA solution, and optionally one or more of a surfactant, a builder, a binding agent, and a chelating agent to form a paste; (iii) delivering the paste to a drum dryer to form a water dissolvable bleach sheet.

21. The method of claim 20, comprising trimming the water dissolvable bleach sheet to a form 1.5-2.0 mm thick, 50-127 mm wide, and 76-203 mm long.

22. The method of claim 20, wherein the polyvinyl alcohol, water, bleaching agent, bleach activator, and pH modifier are mixed in a single homogenizer tank, wherein the homogenizer tank is heated using steam, wherein the drum dryer comprises a heated drying drum having a drive system and a mirror finish, said drying drum mounted over a bottom applicator roller assembly having a bottom feed tray with a bottom feed applicator roller disposed therein, the bottom fed tray having a inlet for receiving the paste, the bottom feed applicator roller in operative contact with paste in the bottom feed tray, wherein rotational engagement between the drying drum and the bottom feed applicator roller forms a water dissolvable bleach sheet.

23. The method of claim 22, comprising trimming the water dissolvable bleach sheet to a form 1.5-2.0 mm thick, 50-127 mm wide, and 76-203 mm long.

24. The method of claim 20, comprising surface spraying the water dissolvable bleach sheet with a surface agent selected from the group consisting of a bleaching agent, a bleach particle, a pH modifying agent, a bleach activator, a surfactant, a builder, a binding agent, a chelating agent, a fragrance, and a combination of one or more thereof.
